(19) United States
(12) Patent Application Publication
(10) Pub. No.: US 2014/0244451 A1
(43) Pub. Date: Aug. 28, 2014

(54) E-COMMERCE TRANSACTION VERIFICATION SYSTEM AND METHOD

(71) Applicant: DARCOM HOLDINGS, INC., Spring, TX (US)

(72) Inventor: Darcy Mayer, Irvine, CA (US)

(73) Assignee: DARCOM HOLDINGS, INC., Spring, TX (US)

(21) Appl. No.: 14/186,930

(22) Filed: Feb. 21, 2014

Related U.S. Application Data
(60) Provisional application No. 61/768,400, filed on Feb. 23, 2013.

(51) Int. Cl. G06Q 20/40; G06Q 40/00

(52) U.S. Cl. CPC G06Q 20/401; G06Q 40/12
USPC 705/30

(57) ABSTRACT

An e-commerce transaction verification system creates documentary verifications of e-commerce transactions between merchants and customers. The system is implemented on a host server cooperating with a program module on the merchant's e-commerce server. The merchant's e-commerce server performs an e-commerce transaction with a customer, and sends transaction data to the host server, including the customer's name, email, address, phone number, physical location, device ID, IP address, signature, image or photo, voice, fingerprint, eye scan, etc., and the amount, confirmation number, time stamp, etc. of the transaction. The host server uses pre-stored templates or documents supplied by the merchant to create a verification document containing some or all of the above information, and stores it. The host server also places an outbound phone call to the customer to collect additional information including voice print, and incorporates it into the verification document. The system allows the merchant to customize the templates.

This application claims priority under 35 USC §119(e) from U.S. Provisional Patent Application No. 61/768,400, filed Feb. 23, 2013, which is herein incorporated by reference in its entirety.

### BACKGROUND OF THE INVENTION

1. Field of the Invention

This invention relates to electronic commerce (e-commerce), and in particular, it relates to an e-commerce transaction verification system for creating documentary verifications of e-commerce transactions between merchants and customers.

2. Description of the Related Art

In typical e-commerce transactions conducted between a merchant's e-commerce website and a customer's computer, once the transaction is complete, the merchant's server sends a transaction receipt to the customer via the web browser and/or a separate email. The transaction receipt typically includes information about the transaction such as description of goods or services, payment amount, time of transaction, and a confirmation number, information about the merchant such as name and address, and customer information such as the customer's name, address, method of payment, etc. The transaction receipt is generated by the merchant server and sent to the customer. Such a receipt may sometimes be insufficient as proof that the e-commerce transaction indeed occurred between the merchant and the customer, in particular when the customer disputes it.

### SUMMARY OF THE INVENTION

The present invention is directed to a method and related apparatus for generating and storing documentary verification of e-commerce transaction that substantially obviates one or more of the problems due to limitations and disadvantages of the related art.

An object of the present invention is to provide a convenient way for merchants to generate and store documentary verification of e-commerce transactions.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method implemented in a host server connected to a requester (merchant's e-commerce server, point-of-sale device operated by merchants, payment gateway server, ISO server, etc.) for generating verification documents for e-commerce transactions, which includes: (a) generating and storing a plurality of templates having a plurality of pre-defined fields; (b) receiving, from a requester, (b1) transaction data regarding an e-commerce transaction with a customer, the transaction data including one or more of: a name of the customer, an email address of the customer, a mailing address of the customer, a phone number of the customer, a device ID of the customer, an IP address of a computer of the customer, signature of the customer, an amount of the transaction, a confirmation number of the transaction, and a time stamp of the transaction, the transaction data further including one or more of: a physical location of the customer, an image or photo of the customer, voice of the customer, a fingerprint of the customer, and an eye scan of the customer, and (b2) either a document or an instruction to use a stored template; (c) determining whether a document or an instruction to use a stored template is received in step (b); (c1) if an instruction to use a stored template is received in step (b), retrieving one of the stored templates, and adding some or all of the received transaction data to one or more pre-defined fields of the template to generate a verification document, the verification document containing some or all of the transaction data received from the requester; (c2) if a document is received in step (b), adding some or all of the received transaction data into the document to generate a verification document, the verification document containing some or all of the transaction data received from the requester; and (d) storing the verification document in a verification database.

The method may also include, after step (b), placing an automated phone call to the customer to collect verification responses and voice data; and after steps (c1) and (c2), embedding the voice data into the verification document.

In another aspect, the present invention provides a method implemented in a system including a host server connected to a merchant e-commerce server, for generating verification documents for e-commerce transactions between the e-commerce server and a customer, the method including: (a) the host server generating, based on input from the e-commerce server, one or more templates each having a plurality of pre-defined fields, and storing the templates in a template database; (b) the e-commerce server performing an e-commerce transaction with a customer via a customer computer; (c) the e-commerce server sending to the host server (c1) transaction data regarding the e-commerce transaction with the customer, the transaction data including one or more of: a name of the customer, an email address of the customer, a mailing address of the customer, a phone number of the customer, a device ID of the customer, an IP address of a computer of the customer, signature of the customer, an amount of the transaction, a confirmation number of the transaction, and a time stamp of the transaction, the transaction data further including one or more of: a physical location of the customer, an image or photo of the customer, voice of the customer, a fingerprint of the customer, and an eye scan of the customer, and (c2) either a document or an instruction to use a stored template; (d) determining whether a document or an instruction to use a stored template is received in step (c); (d1) if an instruction to use a stored template is received in step (c), the host server retrieving one of the stored templates, and adding some or all of the received transaction data to one or more pre-defined fields of the template to generate a verification document, the verification document containing some or all of the transaction data received from the requester; (d2) if a document is received in step (c), the host server adding some or all of the received transaction data into the document to generate a verification document, the verification document containing some or all of the transaction data received from the requester; (e) the host server storing the verification document in a verification database; (f) the host server sending the verification document to the customer via email.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a system in which implements an e-commerce transaction verification system according to embodiments of the present invention.

FIG. 2 schematically illustrates the overall processes according to embodiments of the present invention.

FIG. 3 schematically illustrates a process performed by an input text system of a host server according to an embodiment of the present invention.

FIG. 4 schematically illustrates a process performed by an automated phone system of a host server according to an embodiment of the present invention.

### DETAILED DESCRIPTION OF THE PREFERRED EMBODIMENTS

In this disclosure, for convenience, the term “merchant” is used to refer to the owner or operator (individual or entity) of an e-commerce web site, and the term “customer” is used to refer to an end user (individual or entity) that comes to the e-commerce site to transact business with the merchant. For example, the e-commerce site may be a shopping site, where the merchant is the seller and the customer is the buyer.

A main function of the e-commerce transaction verification system according to embodiments of this invention is to create documentary verifications of e-commerce transactions between merchants and customers.

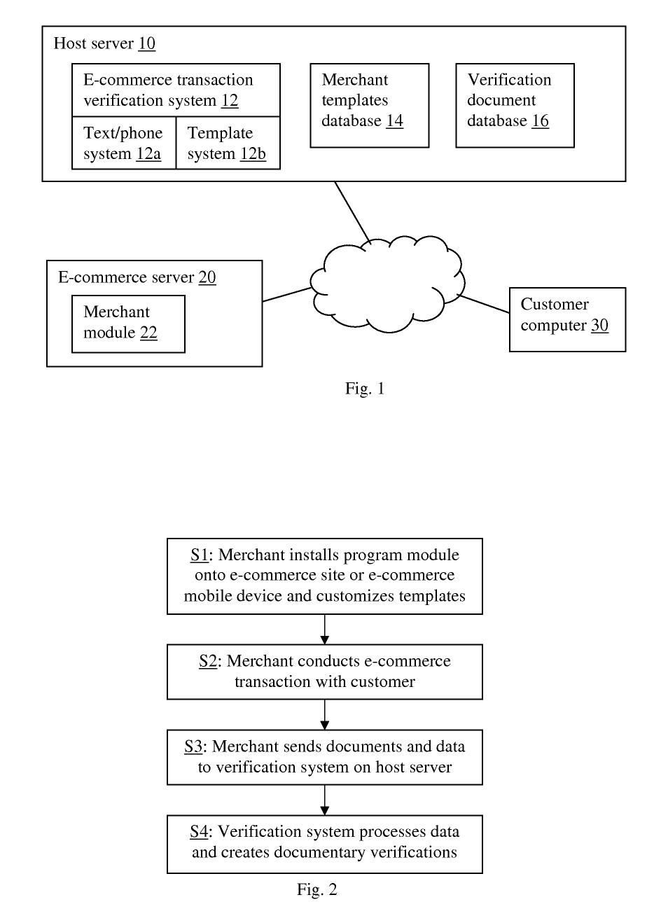

As shown in FIG. 1, the e-commerce transaction verification system may be implemented on a server 10 (referred to as the host server for convenience) that is separate from the server 20 which hosts the merchant's e-commerce site (referred to as the e-commerce server for convenience). The e-commerce server 20 interacts with the host server 10 through a network (e.g. the internet). Alternatively, the host server may be the same as the e-commerce server.

The customer interacts with the e-commerce site hosted on the e-commerce server through a network (e.g. the internet) from the customer's local computer and/or mobile device 30. Through this interaction, the customer can transact business with the merchant.

Embodiments of the present invention, described below, pertain to two processes. The first process (process S1 in FIG. 2) is a setup process, by which the merchant interacts with the host server 10 to integrate the e-commerce transaction verification system into his e-commerce site 20 by installing a program module 22 (referred to as the merchant module) and customizes the templates as will be described in more detail later. The second process (S3 and S4 in FIG. 2) is a verification process that is performed in conjunction with an e-commerce transaction (S2 in FIG. 2) between the merchant's e-commerce server 20 and a customer computer 30. The e-commerce site 20 exchanges various information with the e-commerce transaction verification system 12 on the host server 10, and the e-commerce transaction verification system performs various functions, as will be described in more detail later.

The e-commerce transaction verification system 12 includes two components: an input text system or an automated phone system (which can be used in the alternative) 12a, and a template system 12b. The template system is used during the setup process to allow the merchant to configure templates that will be used to generate verification documents during e-commerce transactions with customers. The input text system and/or the automated phone system are used during the verification process when each e-commerce transaction occurs to generate documentary verifications.

The input text system and the automated phone system 12a allow a merchant a means of creating proof a transaction such as an online e-commerce purchase has taken place. (For convenience, the input text system and/or the automated phone system are collectively or individually referred to as “the verification system(s)”.) The verification systems are designed to allow the verification functions to be easily integrated into any existing website, application, system, etc., and it allows for those merchants to have proof that the transaction did occur with a certain customer. In addition, it may also collect and retain time stamp information, physical location of the customer, the customer's mailing address and phone number, IP address of the customer's computer, the customer's signature (including image of a written signature or other forms of signature), customer's image or photo, customer's voice, fingerprint, eye scan, the customer's device ID, amount of transaction, or any other type of custom information in order to create as much proof as possible that the transaction did occur. Unlike a conventional receipt or transaction correspondence that may be generated after a transaction has occurred, these verification systems will allow the merchant to have proof that not only did the transaction take place, but also further proof by providing the who, what, when, or where of a transaction. In addition, unlike a basic receipt in card not present situations, these verification systems may also provide legal recourse for those merchants to attempt to collect in the event the customer denies the transaction occurred.

The input text system and automated phone system 12a allows their functions to be integrated into any website and/or application by allowing the system to be quickly and easily incorporated into most existing sites and/or applications. The verification systems work with virtually any external systems and/or frameworks such as SOAP (Simple Object Access Protocol), REST (Representational state transfer), Microsoft .Net, PHP (Personal Home or Hypertext Preprocessor), Java, etc. For example, they can be easily integrated into an existing shopping cart, e-commerce site, or any other type of shopping experience. The input system and the automated phone system both work with the template system.

The template system 12b allows the merchant to create custom templates which the system will use to populate data sent to it from the merchant's e-commerce site during an e-commerce transaction. Merchants will usually set up each template once (corresponding to process S1 shown in FIG. 1), but may have the ability to update their templates. Merchants can create virtually any type of templates such as a no refund policies, a credit card authorization forms, etc. The template system also allows merchants to design the layout of the template, e.g. to designate areas where they want certain elements to appear such as an electronic signature in a certain spot within the template the merchant created, files or documents merchants may have sent with their data. The templates so created are stored in a merchant template database 14 on the host server 10.

The merchant's e-commerce site 20 runs a software program (the merchant module 22) that enables the e-commerce site to communicate with the input and automated phone systems, hosted on the host server 10, during or after e-commerce transactions with customers. As mentioned earlier, the input system and the automated phone system may be used in the alternative, and they are collectively or individually referred to as the verification system(s) for convenience. For each e-commerce transaction, the e-commerce site 20 sends to the verification system on server 10 information such as the customer's name, IP address, email address, confirmation number, signature, etc., and other types of information the merchant may require as part of the data package being sent, during an e-commerce transition. The verification systems are also very flexible in that certain information such as customer's name, email, IP address may be required, but the merchant is also able to create their own set of custom information which they will gather or collect from their customers. Merchants can also add their own business rules as to when they want to initiate data being sent to the verification systems during an e-commerce transaction with a customer. For example, a merchant can specify that the e-commerce site will send the collected data either before or after the credit card transaction has completed or verified on their e-commerce sites, and designate the types of data and their corresponding locations in the templates or documents. The e-commerce site 20 can even send their own files or documents such as a PDF documents, HTML, etc. with the data pre-populated or have the input system or automated phone system populate their existing file or document for them.

Once the merchant has integrated the input system or the automated phone system functionality into the e-commerce site 20, the e-commerce site sends data regarding an e-commerce transaction to the verification systems (see FIG. 2, process S3) either before the checkout process, during the checkout process, or even after the checkout process has completed with the customer (process S2), and the verification systems will receive the data along with the document if one has been provided by the e-commerce site (see FIG. 2, process S4). Because the verification systems are also designed or intended to be transparent to the customer, the customer experience may be unaffected. In most cases, the customer will not be aware of the input or automated phone systems are there at all. The Input system and the automated phone system are also capable of handling image files, video files, and/or audio files sent from the merchant's e-commerce site as a part of the data regarding an e-commerce transaction. For added authenticity, the merchant can also place a signature pad on their site and/or application to acquire the customer's signature, or take advantage of the camera in the mobile, tablet, desktop, or any type of device used by the customer to such as either take picture or video of the customer, or take a picture of the customer's license or credit card. The merchant may opt to also use the microphone in the mobile, tablet, desktop, or any type of sound recording device used by the customer to record the customer's voice as well as any other available methods such as eye scanning if the mobile device or computer allows it. The ability for the verification systems to be able to receive such a wide variety of formats allows merchants to have proof when trying to demonstrate that the customer intended on making the transaction and/or verifying the authenticity of that customer. The input system and automated phone system's ability to receive these different types of file formats from the merchant's e-commerce site allows the merchant full customization abilities by allowing the merchants to select what's important to them, which would otherwise be either unavailable or impossible without the input text system or the automated phone system.

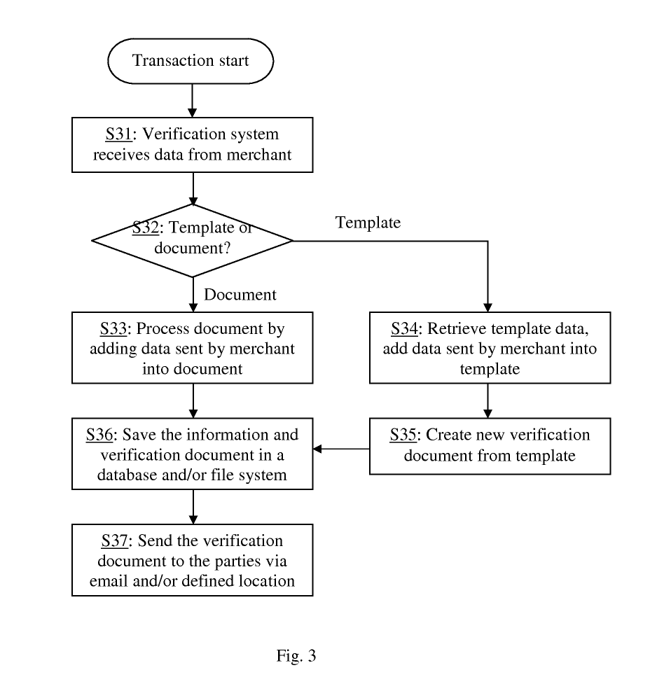

FIG. 3 schematically illustrates the process carried out by the input text system of the host server 10 to generate documentary verifications for e-commerce transactions. During an e-commerce transaction, when the verification systems receive both the required data, and/or custom data regarding an e-commerce transaction from the e-commerce site (step S31), the verification systems will take all of the information it receives from the e-commerce site, and incorporates it into an existing document, template, or a document that the merchant may have also sent with the information, or it may create a new document from a template stored on the host server. Specifically, if the data from the merchant contains an indication to use a pre-stored template (the “template” branch of step S32), the verification system retrieve a template from the database and add data sent by the merchant into template (step S34), and creates a new document from the template (step S35). If the merchant sends their own files or documents as well as additional data (the “document” branch of step S32), the verification system processes the received document by adding data sent by the merchant into the document (step S33); in such a case, the verification system may ignore the pre-stored templates in the database 14, i.e. the templates based on custom settings that may have been defined in the verification systems. The templates or documents allow the merchant to designate areas within them where they want both the required information and custom information to be placed; however, the verification system also allows the merchant to send specific location markers for certain type of elements such as the electronic signature location in the data being sent. When the verification systems incorporate the information either into a document or template, they place the information sent from the e-commerce site into predefined locations such as the name of the customer is in the space where the name is required on the document or template. After the verification systems have processed the information sent from the e-commerce site into the document and/or template or when the verification systems have completed the process of adding all the elements and/or data, they may also add a digital signature or digital certificate to the document and/or template in order to provide proof that the verification systems created the document and may also provide further tamper evidence. As a result, a verification document for the e-commerce transaction is generated. When the verification systems have completed processing the transaction, they may also send an email with the verification document attached to the customer as a form of a receipt or acknowledgment, they may also send a similar email to the merchant or any other email address the merchant has designated (step S37). The systems may also save the information or custom information sent by the e-commerce site, as well as the verification document created after it has been processed for the transaction, in a verification document database 16 on the host server for later retrieval.

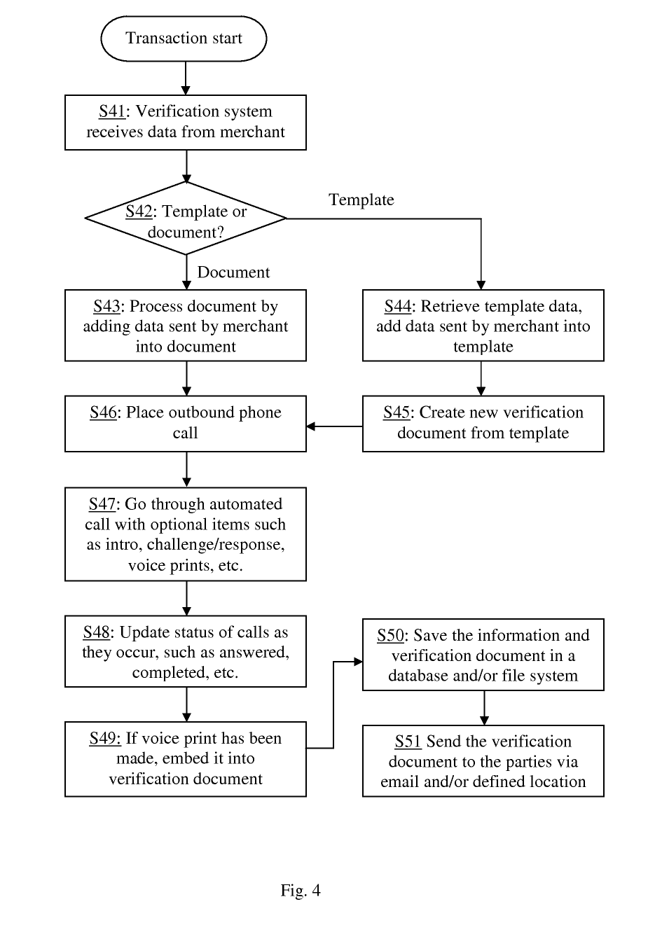

FIG. 4 schematically illustrates the process carried out by the automated phone system of the host server 10 to generate documentary verifications for e-commerce transactions. Although the input text system and the automated phone system function in a similar way (steps S41 to S45, S50 and S51 of FIG. 4 are similar to respective steps S31 to S37 of FIG. 3), the automated phone system goes a step further as it also has the ability to make outbound phone calls to customers to collect more specific data such as challenge/response interactions, voice prints, or any other type of information the merchant may need that the input text system may not be able to do because an outbound call and a mobile device, phone, or any other type of phone device such as VOIP may be required (steps S46 and S47). In some cases, merchants will have the ability to use both the input system and the automated phone system in the transaction because there is a need for both; however, and in most cases merchants only need the input or the automated phone system for their transactions. In one such scenario for example, a merchant may need to send a no refund policy utilizing the input system, but may want to also acquire a credit card authorization utilizing the automated phone system in the same transaction.

The automated phone system will receive similar information as the input text system for the existing document, template, and/or document. In order to utilize the automated phone system, the e-commerce site also provides the phone number, SIP (Session Initiation Protocol) number, or any other type of two way communication number or systems such as skype in order for the automated phone system to be able to make a call to the customer. The e-commerce site has either collected this information during a sign up process that the customer went through, had an agent or representative acquire, or had the customer enter during the e-commerce transaction. The automated phone system can take on many forms, and in one form when the system receives said information from the e-commerce site, it will then initiate a call to the customer after it receives information such as the customer's name, IP address, email address, phone number, confirmation number, signature, amount of the transaction, etc., and whatever other types of information the e-commerce site may send as part of the transaction (step S46). When the customer answers the call, the automated phone system may provide instructions on what needs to be done step by step (step S47). The customer may be prompted to press certain keys on their phone to verify that it is the customer in question and not a machine with basic challenge and response type prompts such as press one if you understand you will be electronically signing this document, which demonstrates the customer's intent to sign in this case. After the automated phone system has gone through its instructions, prompts, challenge and responses, and/or verifications, it may also prompt the customer in order to capture their voice print. The collected voice print may also be saved, and/or it may be used to compare the voice print to an existing database in order to validate it is the customer in question. The automated phone system may also record the entire call session or just a partial of the call session, and after the recording has been made the system may archive the recording and/or embed the recording into the document for the transaction. Merchants may also be able to create their own custom challenge/responses as well as provide custom messages or intros for the automated phone system. The automated phone system may also have the ability to allow merchants to use the text to voice capabilities allowing merchants to create dynamic outgoing messages for their customers.

After the automated phone system has completed going through the prompts, responses, challenge/responses, and/or recordings, the system will incorporate the information it received from the e-commerce site such as the customer's name, IP address, location, phone number, signature, image, email address, etc., as described earlier. The automated phone system may also embed the captured voice print directly into the document as further proof of not only the transaction, but the customer's authenticity (step S49). By embedding the voice print it may also be helpful when the merchants needs some form of evidence to prove it is that customer in question when the customer denies it was him. In addition, the automated phone system may also create hashes or message digests of the voice prints, and save them in databases or file servers as well as even place those hashes in a visible part of the document or within the metadata of the document. The automated phone system may also use the saved voice print data collected from previous calls or available databases to compare voice prints in order to establish authenticity, and provide identity information.

The automated phone system also provides real time status which allows merchants the ability to check the status of the calls in real time using remote systems (step S48). The status can be accessed using technologies such as SOAP, REST, .Net, PHP, etc., allowing it to be easily integrated into any site and/or application. By having the real time status, the merchants will have information available to them such as if the customer answered the call, if it was disconnected, if the customer responded to challenge/responses, if the customer made a recording, etc. As the customer progresses through the automated call, the system is being updated, and this information can be accessed by the merchant. This is important for example if the merchant needs to know if the customer has gone through the entire process before they fulfill the e-commerce transaction (e.g. activate any service or ship any products). For example, the merchant can create a dashboard within a website and/or application where the merchant or the merchant's employee can visually see where the call is at any given time.

Although the e-commerce transaction verification system is described above in the context of e-commerce transaction conducted through a merchant's e-commerce website, the system may also be used in other e-commerce scenarios. One example is e-commerce transacted via certain types of point-of-sale devices operated by the merchant, such as Square credit card reader or the Paypal credit card reader. Unlike a conventional point-of-sale credit card transaction, the Square credit card reader or the Paypal credit card reader can access web services online to obtain information about the credit card owner. In such a scenario, either the point-of-sale devices, or a web server they are connected to, will perform the steps performed by the e-commerce site described earlier.

Another example is use of the e-commerce transaction verification system by payment gateway providers such as credit card transaction processing companies. In this scenario, the payment gateway provider (a server) performs the steps performed by the e-commerce site described earlier. If the verification process is performed by the payment gateway provider, then the e-commerce site will not need to perform these verification steps (i.e., the verification steps are only performed once for each e-commerce transaction involving credit cards).

Yet another example is use of the e-commerce transaction verification system by Independent Service Organization (ISOs) which may have a few merchants or millions of merchants. Paypal is an example of an ISO. In this use scenario, the ISO's server will performs the steps performed by the e-commerce site described earlier.

In the appended claims below, the merchant's e-commerce server, point-of-sale device operated by merchants, payment gateway server, ISO server, etc. can be generally referred to as the “requester.”

It will be apparent to those skilled in the art that various modification and variations can be made in the e-commerce transaction verification system and method of the present invention without departing from the spirit or scope of the invention. Thus, it is intended that the present invention cover modifications and variations that come within the scope of the appended claims and their equivalents.

What is claimed is:

1. A method implemented in a host server connected to a requester for generating verification documents for e-commerce transactions, comprising:
(a) generating and storing a plurality of templates having a plurality of pre-defined fields;
(b) receiving, from a requester, (b1) transaction data regarding an e-commerce transaction with a customer, the transaction data including one or more of: a name of the customer, an email address of the customer, a mailing address of the customer, a phone number of the customer, a device ID of the customer, an IP address of a computer of the customer, signature of the customer, an amount of the transaction, a confirmation number of the transaction, and a time stamp of the transaction, the transaction data further including one or more of: a physical location of the customer, an image or photo of the customer, voice of the customer, a fingerprint of the customer, and an eye scan of the customer, and (b2) either a document or an instruction to use a stored template;
(c) determining whether a document or an instruction to use a stored template is received in step (b);
(c1) if an instruction to use a stored template is received in step (b), retrieving one of the stored templates, and adding some or all of the received transaction data to one or more pre-defined fields of the template to generate a verification document, the verification document containing some or all of the transaction data received from the requester;
(c2) if a document is received in step (b), adding some or all of the received transaction data into the document to generate a verification document, the verification document containing some or all of the transaction data received from the requester; and
(d) storing the verification document in a verification database.

2. The method of claim 1, further comprising:
after step (b), placing an automated phone call to the customer to collect verification responses and voice data; and
after steps (c1) and (c2), embedding the voice data into the verification document.

3. The method of claim 2, further comprising: providing to the merchant server updated status of phone calls in real time

4. The method of claim 1, wherein in step (a), the templates are generated based on input from the requester.

5. A method implemented in a system including a host server connected to a merchant e-commerce server, for generating verification documents for e-commerce transactions between the e-commerce server and a customer, the method comprising:
(a) the host server generating, based on input from the e-commerce server, one or more templates each having a plurality of pre-defined fields, and storing the templates in a template database;
(b) the e-commerce server performing an e-commerce transaction with a customer via a customer computer;
(c) the e-commerce server sending to the host server (c1) transaction data regarding the e-commerce transaction with the customer, the transaction data including one or more of: a name of the customer, an email address of the customer, a mailing address of the customer, a phone number of the customer, a device ID of the customer, an IP address of a computer of the customer, signature of the customer, an amount of the transaction, a confirmation number of the transaction, and a time stamp of the transaction, the transaction data further including one or more of: a physical location of the customer, an image or photo of the customer, voice of the customer, a fingerprint of the customer, and an eye scan of the customer, and (c2) either a document or an instruction to use a stored template;
(d) determining whether a document or an instruction to use a stored template is received in step (c);
(d1) if an instruction to use a stored template is received in step (c), the host server retrieving one of the stored templates, and adding some or all of the received transaction data to one or more pre-defined fields of the template to generate a verification document, the verification document containing some or all of the transaction data received from the requester;
(d2) if a document is received in step (c), the host server adding some or all of the received transaction data into the document to generate a verification document, the verification document containing some or all of the transaction data received from the requester;
(e) the host server storing the verification document in a verification database;
(f) the host server sending the verification document to the customer via email.

6. The method of claim 5, further comprising:
after step (c), placing an automated phone call to the customer to collect verification responses and voice data; and
after steps (d1) and (d2), embedding the voice data into the verification document.

7. The method of claim 6, further comprising: providing to the merchant server updated status of phone calls in real time
